(19) United States
(12) Patent Application Publication
(10) Pub. No.: US 2013/0153460 A1
(43) Pub. Date: Jun. 20, 2013

(54) BLISTER PACK

(71) Applicants: Stephan KURTZE, Ingelheim am Rhein (DE); Stefan LUSTENBERGER, Gensingen (DE)

(72) Inventors: Stephan KURTZE, Ingelheim am Rhein (DE); Stefan LUSTENBERGER, Gensingen (DE)

(73) Assignee: Boehringer Ingelhleim International GmbH, Ingelheim am Rhein (DE)

(21) Appl. No.: 13/772,522

(22) Filed: Feb. 21, 2013

Related U.S. Application Data
(63) Continuation of application No. 13/058,058, filed on Mar. 24, 2011.

(30) Foreign Application Priority Data
Aug. 11, 2008 (EP) 08162175.7

(51) Int. Cl. A61J 1/03

(52) U.S. Cl. CPC A61J 1/035
USPC 206/531

(57) ABSTRACT

A blister pack comprises a bottom film and a top film for forming a plurality of film containers (1) that can be separated from one another by perforations (10), each having one accommodating chamber (2) for a filling, particularly a pharmaceutical active substance formulation, the accommodating chambers (2) being arranged around the peripheral boundary of the blister pack (7). The centre of the blister pack (7) is formed by a detachable film section (4), after the removal of which an opening region (5) is available for opening the accommodating chamber (2).

The invention relates to a blister pack having a bottom film and a top film for forming a plurality of film containers that can be separated from one another, each having one accommodating chamber for a filling, particularly a pharmaceutical active substance formulation, the accommodating chambers being arranged around the peripheral boundary of the blister pack.

The invention further relates to a blister pack having a bottom film and a top film for forming a plurality of film containers that can be separated from one another by means of perforations, each having one accommodating chamber for a filling, particularly a pharmaceutical active substance formulation, the rectangular film containers being arranged in a matrix.

Film containers are used, among other things, for protecting pharmaceutical active substance formulations from external environmental effects, which in some circumstances may affect the pharmaceutical quality of the active substance formulation, and generally consist of a top film and a bottom film, with cavities for the filling provided in the bottom film. The top film and the bottom film may be made up of one or more layers of the same or different materials. The top film is attached to the bottom film in sealed manner for example by adhesive bonding, welding or sealing. The top film and/or the bottom film are generally in the form of a metal and/or plastic and/or paper film. These materials may be present in a plurality of layers. Typical metal films include for example aluminium films and composite aluminium films which are made from aluminium and a plastic, for example. The material used for the plastic films may be polyvinylchloride (PVC), cyclo-olefin-copolymer (COC), polychlorotrifluoroethylene (PCFE), polyethylene (PE), polypropylene (PP), polyethylene terephthalate (PET), polycarbonate (PC), polyester (UP), polyacrylate, polyamide (PA) or another plastic or a multi-layer composite plastic film, consisting for example of a combination of polychlorotrifluoroethylene (PCTFE), which is known particularly by the brand name Aclar® registered as a trade mark by Honeywell International, Inc., with polyvinylchloride (PVC) or polyvinyl chloride (PVC) with polyvinylidene chloride (PVdC). Often a film container or blister consists of an aluminium top film which seals the bottom film to accommodate the pharmaceutical product or active substance. This thermoformed bottom film may also comprise an aluminium foil to prevent water from entering the cavity for holding the pharmaceutical product. In order to create another diffusion barrier or increase the mechanical stability of the blister, the aluminium foil of the bottom film or the top film may optionally be covered on one or both sides with additional plastic and/or paper films.

In some states regulations on childproof packaging of medical products are being considered or are already in existence, to make it difficult for children to get hold of medicaments, in particular, which have a toxic effect or constitute a relatively serious risk to health if used inappropriately.

The problem of the invention is to provide a film container of the type mentioned hereinbefore in which the removal of a filling is determined by the shape of the film container, and which has good childproof properties.

According to the invention the problem is solved by the fact that the centre of the blister pack is formed by a film section that can be detached and after its removal an opening region is provided for opening the accommodating chamber.

Because of these measures it is necessary first to detach the film section from the central region of the blister pack to allow subsequent access to the opening region of the individual film containers and enable the corresponding accommodating chambers to be opened in order to remove the filling. The number of operating steps required provides additional childproofing for the blister pack, as the method of opening the accommodating chamber is unusual and hence more difficult for a child. An adult, on the other hand, will readily be able to grasp and implement the processes for opening the accommodating chamber.

Within the scope of the invention the term “perforation” denotes both an actual punching through of a material or of a plurality of layers or plies of a material of the blister pack, and a thinning of the material, a bending line, fold line, embossed marking or the like. Perforations of this kind may be produced by machine during the manufacture of the blister pack to enable individual film containers to be torn off or separated.

To simplify the detachment of the film section from the blister pack, a perforation running in a circle around the film section is expediently associated with the film section.

To enable a user to take a section of the blister pack away with him, the film containers may be separated into segments.

Preferably, the perforation between the film containers does not extend to the outer periphery of the blister pack. Thus, accidental tearing or separation of the film container along the perforations from the edge or periphery of the blister pack is effectively prevented. As a result, a user can only detach the film container starting from the centre, to gain access to the according to or to separate the film container from the rest of the blister pack.

According to one feature, the film containers are arranged relative to one another with an outer contour in the form of a polygon, circle or oval. The arrangement allows a plurality of film containers to be put together to form a blister pack, each film container only being capable of being opened from the centre.

Alternatively, the problem according to the invention is solved, in a blister pack having a bottom film and a top film to form a plurality of film containers that can be separated from one another by means of perforations, each having an accommodating chamber for a filling, particularly a pharmaceutical active substance formulation, the rectangular film containers being arranged to form a matrix, by the fact that the film containers can be separated in a spiral configuration, wherein the perforation is provided in certain areas between pairs of adjacent film containers, and in the region of the perforation, an opening region is provided for removing the filling from the accommodating chamber.

The spiral arrangement of the film containers and hence of the accommodating chambers as well determines the sequence of opening or separating the individual accommodating chambers each of which is filled with a pharmaceutical active substance formulation. The film containers have to be separated in a particular sequence that produces a spiral to enable the user to reach the opening region. The spiral shape is ensured for example by corresponding non-perforated regions between the film containers. Clearly, only one opening region is provided on each film container. The unusual method of operation provides childproofing, as the method of opening the accommodating chamber is unusual and hence more difficult for a child. An adult, on the other hand, will readily be able to grasp and implement the processes for opening the accommodating chamber.

According to a further feature, the opening region is constructed as a gripping tab for removing the top film. The top film is not connected to the bottom film over its entire area in the opening region, or is sealed less firmly. Thus, the cover film that rests relatively loosely on the bottom film or can be pulled away from the bottom film relatively easily is relatively easily lifted and pulled or torn away from the bottom film by a user, in the opening region, in order to open the accommodating chamber to allow access to the filling in the accommodating chamber.

Alternatively, the opening region comprises a notch or a cut as a weakened area of the bottom film and/or the top film. Conveniently, the notch or the cut extends from one edge region of the film container centrally towards the accommodating chamber. Along the notch or cut, the film container can be torn open as far as the accommodating chamber to remove the filling.

Clearly, the blister pack may be marked with corresponding inscriptions or print consisting of numbers, days of the week or the like, to indicate the correct sequence for removing the filling from the accommodating chambers.

Preferably, the bottom film is made of plastics, aluminium or a combination of these materials. The shape, size and number of the various cavities of the accommodating chambers in the bottom film are adapted to the filling that is to be placed therein, such as a tablet or the like, for example. Naturally, a single blister pack may comprise a plurality of film containers having the corresponding number of accommodating chambers. The bottom film is produced, for example, on the side facing the filling, from a layer of polyvinylchloride (PVC) that is approximately 60 μm thick, followed by a roughly 45 μm thick aluminium film, which is in turn attached to a roughly 25 μm thick film of an oriented polyamide (oPA).

Advantageously, the top film is a composite aluminium film, which consists, for example, on the side facing the filling, of an aluminium film roughly 20 μm thick and attached thereto a film, roughly 23 μm thick, of a polyethylene terephthalate (PET). Clearly, the bottom film and the top film may also be identical or made from other materials.

It will be understood that the features mentioned above and about to be explained hereinafter may be used not only in the particular combination specified but also in other combinations. The scope of the invention is defined only by the claims.

The invention is hereinafter explained in more detail by means of a number of embodiments by way of example, with reference to the associated drawings, wherein:

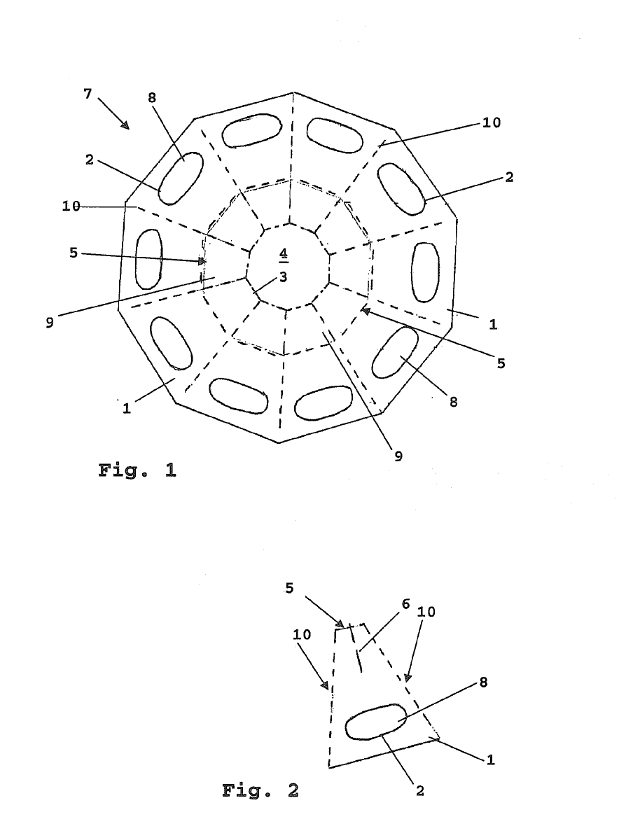

FIG. 1 shows a plan view of a blister pack according to the invention,

FIG. 2 shows a plan view of an alternative film container of the blister pack according to FIG. 1 and

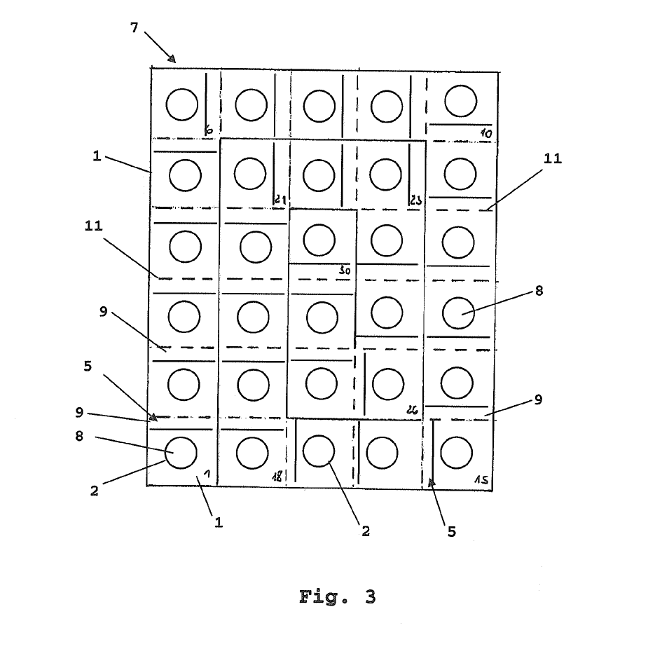

FIG. 3 shows a plan view of an alternative embodiment of a blister pack.

The blister pack 7 containing a plurality of film containers 1 comprises a bottom film with cavities 8 and a top film, which is attached to the bottom film in suitable manner, preferably using a heat-seal lacquer, to form closed accommodating chambers 2 in the region of the cavities 8, each for at least one filling, particularly a pharmaceutical active substance formulation.

According to FIG. 1 in the blister pack 7 the individual film containers 1 are arranged relative to one another in the form of a polygon and the individual accommodating chambers 2 are located at the peripheral boundary of the blister pack 7. Arranged in the centre of the blister pack 7 is a film section 4 in which there is no accommodating chamber 2, and which can be detached from the blister pack by means of a substantially circular perforation 3. Adjoining the film section 4 are defined opening regions 5 for opening the accommodating chambers 2 of the segment-shaped film containers 1. The individual film containers 1 can be separated from one another by means of perforations 10 which start from the perforation 3, while the perforations 10 between the film containers 1 do not extend up to the periphery of the blister pack 7, to ensure that detachment of the film containers 1 from outside is difficult and is easily carried out from the direction of the centre after the film section 4 has been removed.

In order to open the accommodating chambers 2 of the film containers 1, first of all the film section 4 in the centre of the blister pack 7 has to be detached along the perforation 3 which is provided continuously around its periphery. Then, a user of the blister pack 7 can separate the film containers 1 from one another by separating the perforations 10 extending in a star-shaped arrangement, thus making it considerably easier to open the accommodating chambers 2. The opening region 5 is constructed as a gripping tab 9 for pulling the top film away from the bottom film, while the top film is not attached to the bottom film over its whole area in the opening region 5, or is sealed less firmly.

In the alternative embodiment of the film container 1, as shown in FIG. 2, a cut 6 is provided in the opening region 5 as a weakened area of the bottom film and top film and thus constitutes a tearing aid which extends centrally from an edge region of the film container 1 facing into the centre of the blister pack 7 in the direction of the accommodating chamber 2. To remove the filling, the user tears open the film container 1 as far as the accommodating chamber 2.

According to FIG. 3 in the alternative blister pack 7 rectangular film containers 1 which can be detached in a spiral configuration are arranged to form a matrix. Between pairs of adjacent film containers 1 there is a perforation 11 in parts and in the region of the perforation 11 the opening region 5 for removing the filling from the accommodating chamber 2 is provided, while the opening region 5 may be configured as explained hereinbefore. In some regions of the blister pack 7 there is no perforation 11 between the film containers 1 to ensure a spiral separation. In the regions without a perforation 11 there may be a weakening of the material of the bottom film and top film to make the film containers 1 more difficult to open but nevertheless to enable them to be opened. To explain the sequence of removal of the individual film containers 1, the blister pack 7 is printed accordingly with numbers 1 to 30.

What is claimed is:

1. A blister pack having a bottom film and a top film for forming a plurality of film containers (1), which through perforations (10) can be separated from one another, each having one accommodating chamber (2) for a filling, the accommodating chambers (2) being arranged around the peripheral boundary of the blister pack (7), characterised in that the centre of the blister pack (7) is formed by a detachable film section (4), after the removal of which an opening region (5) is available for opening the accommodating chamber (2).

2. The blister pack according to claim 1, characterised in that associated with the film section (4) is a perforation (3) that runs in a circle around it.

3. The blister pack according to claim 1, characterised in that the film containers (1) can be separated into segments.

4. The blister pack according to claim 1, characterised in that the perforation (10) between the film containers (1) does not extend right up to the outer periphery of the blister pack (7).

5. The blister pack according to claim 1, characterised in that the film containers (1) are arranged relative to one another with the outer contour of a polygon, circle or oval.

6. A blister pack having a bottom film and a top film for forming a plurality of film containers (1) that can be separated from one another by perforations (11), each having one accommodating chamber (2) for a filling, the quadrilateral film containers (1) being arranged to form a matrix, characterised in that the film containers (1) can be separated in a spiral configuration, while between pairs of adjacent film containers (1) the perforation (11) is provided in certain areas, and in the region of the perforation (11) an opening region (5) is provided for removing the filling from the accommodating chamber (2).

7. The blister pack according to claim 1, characterised in that the opening region (5) is configured as a gripping tab (9) for pulling off the top film.

8. The blister pack according to claim 1, characterised in that the opening region (5) has a notch or a cut (6) as a weakened area in the bottom film and/or top film.

9. The blister pack according to claim 8, characterised in that the notch or the cut (6) extends centrally from an edge region of the film container (1) towards the accommodating chamber (2).

10. The blister pack according to claim 1, characterised by inscriptions or print consisting of numbers, information relating to days of the week or the like.

11. The blister pack according to claims 1, characterised in that the bottom film consists of plastics, aluminium or a composite of these materials.

12. The blister pack according to claim 1, characterised in that the top film is a composite aluminium film.

13. The blister pack according to claim 1 wherein the filling is a pharmaceutical formulation.

14. The blister pack according to claim 6 wherein the filling is a pharmaceutical formulation.
